(19) United States
(12) Patent Application Publication
(10) Pub. No.: US 2018/0165589 A1
(43) Pub. Date: Jun. 14, 2018

(54) WEARABLE DEVICE CONTROL WITH INFERRED INSIGHTS

(71) Applicant: Microsoft Technology Licensing, LLC, Redmond, WA (US)

(72) Inventors: Shira Weinberg, Tel Aviv (IL); Igal Amster, Tel Aviv (IL); Ariel Baruch, Tel Aviv (IL)

(21) Appl. No.: 15/377,480

(22) Filed: Dec. 13, 2016

(51) Int. Cl. G06N 5/04; G06N 7/00; G06F 1/16

(52) U.S. Cl. CPC G06N 5/048; G06F 1/163; G06N 7/005

(57) ABSTRACT

A wearable electronic device is capable of changing its appearance or physical characteristics or creating output that is entertaining or useful to the user. An inference engine collects context data inputs from a variety of source to output new inferred insights to update a persistent inferred state describing the situational context of the user. A situational context predictor accepts data sensed from the wearable device and/or environmental data to predict a situational context that is likely to describe the user's current situational context. A controller transmits control commands to the wearable electronic device to cause the wearable electronic device to provide services or to change it appearance or physical characteristics based on the inferred insights.

### BACKGROUND

Electronic devices, including wearable devices integrated into clothing, may provide feedback or services to a user. The feedback and services rendered by wearable devices are dependent on data sensed by the wearable device or on data sent to the wearable device from a server. Often, the data available to the server and the data sensed by the wearable device are insufficient to provide the most appropriate feedback or services to the user of the wearable device for the user's current situational context.

### SUMMARY

An electronic device, such as a wearable device including a piece of clothing (e.g. a shirt, shoes, etc.), an accessory (e.g., a watch), etc., is capable of changing its appearance or physical characteristics (e.g., using e-textile technology, embedded technology), creating output (visible, audible, olfactory, etc.) that is entertaining or useful to the user. The wearable electronic device is responsive to control commands received from a controller. The control commands are based on a predicted situational context of the individual user. The predicted situational context is determined based on “inferred insights.” As used herein, “inferred insights” are characterizations extracted from a persistent inferred state representing the user that denote information regarding the user that is not expressly available. The persistent inferred state is based on information potentially including, without limitation, data describing the user, metadata about the user, the user's real-world activities and interactions, and communications made by the user in combination with data sensed by the wearable device, which is equipped with various sensors to detect data directly from the user or from the environment surrounding the user. The persistent inferred state representing the user is updated by a variety of context data inputs and/or mined data that are collected from sources of data relating to the individual user including without limitation from interactions between the user and the user's personal digital assistant, the user's habitual data, data mined from online sources regarding the user, online profile information regarding the user, data supplied by the user, etc. A situational context is predicted based on the updated persistent state, data regarding the user's environment, data sensed from the wearable electronic device, etc.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 is a schematic diagram of an example system for controlling a wearable device associated with an individual user based on inferred insights.

FIG. 2 is a schematic diagram of the components of an example inference engine.

FIG. 3 is a signal diagram illustrating example communications among an inference engine, a situational context predictor, a wearable device, and sources of data.

FIG. 4 illustrates example control of an electronic wearable device with inferred insights.

FIG. 5 illustrates an additional example control of an electronic wearable device with inferred insights.

FIG. 6 illustrates an additional example control of an electronic wearable device with inferred insights.

FIG. 7 illustrates example operations for generating inferred insights to determine control commands to send to a wearable device associated with an individual user.

FIG. 8 illustrates an example system for use in an inference engine.

### DETAILED DESCRIPTIONS

An electronic device, such as a wearable device including a piece of clothing (e.g. a shirt, shoes), an accessory (e.g., a watch), etc., is capable of changing its appearance or physical characteristics (e.g., using e-textile technology, embedded technology) and/or creating output (visible, audible, olfactory, etc.) that is entertaining or useful to the user. For example, the electronic wearable device may change colors to suit a situational context or display an image or video with a particular relevance to the user. As another example, the electronic wearable device may create an audible output such as playing a song, sound clip, an audible notification for the user, etc. As yet another example, the electronic wearable device may change its physical characteristics such as size or shape, such as shoes becoming tighter when the user walks faster or runs or a tie loosening the knot after the end of a social event. In yet another example, the electronic wearable device may use haptic feedback to “tap” the user on the shoulder to notify the user of an event or circumstance such as an incoming communication or of the user's proximity to an area or location of interest to the user.

The wearable electronic device is controlled by control commands received by the user, an associated device, or from a remote server over a communications link with the wearable electronic device. The remote server includes a controller configured to transmit control commands to the wearable electronic device based on “inferred insights” regarding the user and the user's situational context. Data describing the user may include a variety of context data inputs and/or mined data that are collected from sources of data relating to the individual user including without limitation from interactions between the user and the user's personal digital assistant, the user's habitual data, data mined from online sources regarding the user, online profile information regarding the user, data supplied by the user, etc.

Inferred insights are used to generate an adjustable persistent inferred state representing the user. A persistent inferred state representing the user is a mutable entity that is updated, refined, adjusted, or altered based on the quality and/or selection of the available context input data to more accurately represent the collection of inferences made or known about the user at a point in time. For example, aspects of a persistent inferred state that are deemed to have been based on stale data or data that is growing stale may be removed from the persistent inferred state or the weighting of that data may be diminished. Aspects of the persistent inferred state that are based on data that has been deemed to have been superseded by new data are removed. The persistent inferred state, however, need not be dependent entirely on recently collected data. Aspects of the persistent inferred state that are based on data that is deemed to be valid, even if the data is old, persists until there is an indication that the data has been superseded or is no longer an accurate representation of the user. On the other hand, the persistent inferred state also need not persist indefinitely. An inference engine may entirely delete a persistent inferred state and begin again with new inferred insights about the user. The persistent inferred state is not a description of the user's actual situational context, but rather is a framework for determining the user's actual situational context based on real-time data. A situational context is predicted based on the updated persistent state, data regarding the user's environment, data sensed from the wearable electronic device, etc.

As an example of an inferred insight, the persistent inferred state representing the user may include rules to determine whether a user should be interrupted by an incoming call in the user's current situational context. If the persistent inferred state representing the user includes the relationship of contacts in the user's contact list to the user, and the user's calendar entry includes a dinner with the user's spouse at a location and time that matches real-time location data sensed by the wearable electronic device, a situational context predictor may determine that the user is at dinner with the user's spouse and incoming communications should not interrupt the user or should interrupt the user only in an unobtrusive way. As another example, the persistent inferred state representing the user includes that one of the contacts in the user's contact list is a babysitter who may babysit the user's child. The inference engine may create a new inferred insight that the user would wish to be interrupted during the dinner with his spouse by an incoming communication if the incoming communication is from the babysitter because the content of the communication may be relevant to the safety of his child. Other examples of inferred insights will become apparent from the disclosure presented herein.

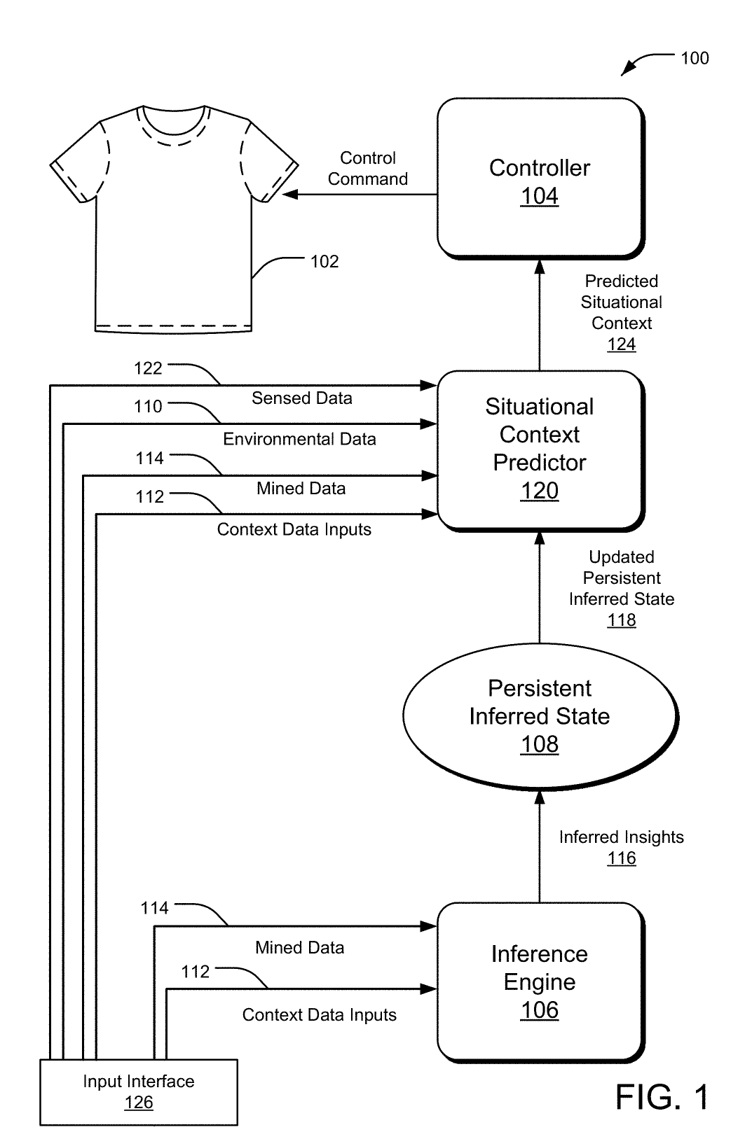

FIG. 1 is a schematic diagram of an example system 100 for controlling a wearable device 102 associated with an individual user based on inferred insights. New inferred insights are generated at an inference engine 106 and used to update a persistent inferred state 108 associated with the individual user. The inference engine 106 implements methods for collecting or harvesting data relating to the individual user and perform analysis on the data relating to the individual user to form the basis for the updates to the persistent inferred state 108 associated with the individual user. The inference engine 106, situational context predictor 120, and controller 104 may be located in the same physical location or in different physical locations. In at least one implementation, the inference engine 106, situational context predictor 120, and controller 104 are located in a cloud-based system. In other implementations, one or more of the inference engine 106, situational context predictor 120, and controller 104 are located on the wearable electronic device 102. In yet other implementations, one or more of the inference engine 106, situational context predictor 120, and controller 104 are located on devices associated with the user such as a smartphone, laptop, or other electronic device that is in communications with the electronic wearable device 102.

Sources of data collected or harvested by the inference engine 106 includes mined data 114. Mined data 114 may originate from a variety of sources available to the inference engine 106. In an example, mined data 114 may be collected from social media accounts associated with the individual user. Mined data 114 from social media accounts may include lists of contacts, friends, followers, or persons the individual user follows or to whom the user subscribes. Mined data 114 from social media accounts may also include physical real-world locations that the user has visited, the frequency of the user's visits to those locations, whether the user has visited the locations recently, whether the user has submitted reviews of the physical locations (e.g., a review of a dining experience at a restaurant, a review of a music venue, a public facility such as a park or museum). Mined data 114 may also include information regarding which of the user's contacts the user frequently interacts with and the content of those interactions. In an example, the mined data 114 includes contacts with whom the user has been tagged in photos, contacts with whom the user has attended events or locations, contacts who are identified as relations to the user such as family relations, current or former, schoolmates, co-workers, whether the user is in the same group as certain contacts (e.g., membership on a sports team, membership in a community organization, association with a political or religious group).

Another source of data collected or harvested by the inference engine 106 includes context data inputs 112. Context data inputs encompass a variety of sources of information relating to a situational context the user may enter. In an example, the user employs a virtual assistant one on or more devices. A virtual assistant has access to information relating to the user including the user's calendar, the user's travel plans, the user's website and social media searches, the user's social media postings, etc. These sources of information contain explicit information regarding situational contexts the user is likely to encounter. For example, if the user's calendar includes an entry for a lunch meeting at a specified date and time with a business associate, then there is a probability that the user will interact with that business associate at the calendared date and time. If the user has requested public transit directions from the user's office to the lunch meeting location, then there is an increased probability that the user will attend the calendared event. The virtual assistant may access the user's website searches that indicate topics of interest to the user such as a favorite sports team, a political affiliation, hobbies and favored activities, favorite artists, etc.

In another example, the context data inputs 112 include communications sent to or by the user. The user's email includes a list of contacts and may be parsed for keywords associated with particular contacts. If a certain contact of the user communicates with the user regarding soccer, then there is an indication that the contact is a member of the user's soccer team. Social media postings are also types of communications sent to or by the user that may be parsed to extract keyword data indicating topics of interest to the user.

In yet another example, the context data inputs 112 include “profile” data associated with the user. If the user consults a mapping service to request travel directions, then the user may have entered the address of locations at which the user is commonly present (e.g., office, home, school). Profile data may also include historical or habitual data relating to the user. If the user habitually attends the gym at a certain hour before leaving to go to work, then the context data indicates a probability that the user will be at the gym at the user's usual time. Historical data also includes personal data that has been sensed by a device associated with the user. If the user employs a fitness tracking device, then historical data relating to the user's physiological state (e.g., blood sugar levels, steps taken per day, distance traveled, hart rate levels, blood pressure) may be known. The physiological state data may be combined with other data relating to the user such as the user's physical location history and proximity to a contact in the user's contact list to determine that the user sometimes engages in activities (e.g., bicycling, skiing, walking with a certain friend occasionally).

The mined data 114 and context data inputs 112 are inputs to the inference engine 106. The inference engine 106 analyzes the input data to generate new inferred insights regarding the user. Inferred insights are inferences that are not explicitly included in the input data. For example, a calendar entry for a dentist appointment at a date and time at a location is not an inferred insight because that information is explicitly included in the context data inputs 112. On the other hand, a determination that the user's dentist attended the same university as the user based on data mined from a user interaction with the dentist on a social media platform combined with a determination that the user and the dentist have attended football games together in the past could give rise to an inferred insight that the dentist is a fan of the university's football team. That the dentist is a fan of the university's football team is an inferred insight that could be used later by the system to select a control command to the wearable electronic device 102, such as display of the university's logo on the wearable electronic device or display of a replay of the university's football team highlights when the dentist enters the room, as explained in more detail herein.

The inference engine 106 outputs new inferred insights to update a persistent inferred state 108 associated with the user. The persistent inferred state 108 associated with the user is based on the constellation of data inputs from the mined data 114 and the context data inputs 112 that describes the current situational context of the user. The persistent inferred state 108 is not merely based on explicit data contained in the data inputs from the mined data 114 and the context data inputs 112, but also includes new inferred insights provided by the inference engine 106. New inferred insights provided by the inference engine 106 update the persistent inferred state 108 into updated persistent inferred state 118 to include the new inferred material and provide a more accurate representation of the user's situation and the behavior of the wearable electronic device 102 that are desired by the user and appropriate for the user's situational context.

A situational context predictor 120 accepts the updated persistent inferred state 118 as an input and applies additional information to output a predicted situational context 124. The additional information relied upon by the situational context predictor 120 includes sensed data 112 and environmental data 110. In at least one implementation, the additional information relied upon by the situational context predictor 120 is real-time data. In at least one implementation, situational context predictor 120 also receives data that was available to the inference engine 106, including mined data 114 and context data inputs 112.

Sensed data 112 includes data supplied by embedded sensors in the wearable electronic device 102. Examples of embedded sensors in the wearable electronic device 102 include light sensors, location sensors (e.g., a GPS receiver, a Wi-Fi SSID detector, a cellular radio for triangulation) blood pressure sensors, glucose rate sensors, oxygen rate sensors, accelerometers, body temperature sensors, ambient temperature sensors, microphones, near field communication sensors, communications antennas such as Bluetooth, Wi-Fi, etc. The sensed data 112 provides a real-time indication of the environment surrounding the wearable electronic device 102 at a certain point in time, and thus confirms or undermines the likelihood that the updated persistent inferred state 118 accurately reflects the true situational context experienced by the user. Sensed data also includes data input by the user into an input interface of the wearable device 102, for example without limitation, via a hardware or software keyboard, a touch interface, physical controls on the wearable device 102, or via another device. As such, the user may communicate with the inference engine 106 and the situational context predictor 120 directly or indirectly via the wearable device 102.

As an example, if the updated persistent inferred state 118 infers that the user will be at work in an office setting, and thus and control commands sent to the wearable electronic device 102 should be compatible with such an environment (e.g., low volume audio tones, non-obj ectionable subject matter displayed on the wearable electronic device 102, fit of the clothing consistent with workplace attire), but the sensed data 112 indicates a highly illuminated environment, an elevated heart rate, then the situational context predictor 120 may output a predicted situational context 124 that is consistent with trail running in the mountains rather than in an office setting.

As another example, if the updated persistent inferred state 118 infers that the user will be a spectator at a child's soccer game, and thus and control commands sent to the wearable electronic device 102 should be compatible with such an environment (e.g., high volume audio tones, non-objectionable subject matter displayed on the wearable electronic device 102, fit of the clothing consistent with physical activity), but the environmental data 110 indicates a high likelihood of heavy rain at the date, time, and place of the child's soccer game, then the situational context predictor 120 may output a predicted situational context 124 that is consistent with a situational context that is different from spectating at the child's soccer game because it is unlikely that the user will actually be in that environment. Environmental data 110 may include any information collected or harvested regarding an environment either predicted by the updated persistent inferred state 118 or indicated by the sensed data 112 that is relevant to the user's situational context. As a non-limiting examples, environmental data 110 may include weather data or weather forecast data, data regarding the cancellation of an event, traffic data, crowdsourced data, data regarding the availability of car parking, data regarding the presence or absence of persons in the user's contact list, emergency responder data (e.g., if more than several emergency responders are at or are en route to an area, the user may not wish to go to that area), geography data (e.g., there is not enough snow for skiing in an area, it is too windy to surf in an area), and/or disaster data (e.g., an earthquake or fire has been detected in an area).

An input interface 126 is configured to receive the source of data described herein (e.g., context data inputs 112, mined data 114, environmental data 110, sensed data 122) The input interface 126 may be configured as a network interface for making network requests (e.g., HTTP requests) to sources of data available to the input interface 126 over a network connection such as over a public network (e.g., to retrieve data from social networks, environmental data sources) In at least one implementation, the input interface 126 is configured to receive sources of data from one or more accounts associated with a user. Information in accounts associated with a user may not be publicly available information and may require user of the user's credentials to access the data (e.g., data available from the user's interactions with a digital personal assistant, data in the user's communications accounts such as e-mail or text message accounts, data from the user's devices, data from other accounts the user may own such as travel data gleaned from a mapping service)

Controller 104 accepts the predicted situational context 124 from the situational context predictor 120, and determines a control command to control the wearable device 102 associated with the user based on the predicted situational context 124. For example, if the predicted situational context 124 indicates an informal social context from an inferred insight 116 supplied by the inference engine 106 and the sensed data 122 indicates a low-light intensity environment, then the control command output by the controller 104 to the wearable electronic device 102 may be a command for the wearable electronic device 102 to change the color of the wearable electronic device 102 into glowing colors. As another example, if the predicted situational context 124 indicates a business context and the sensed data 122 indicates a person in the user's contact list is close by, and the inferred insight 116 supplied by the inference engine 106 infers that the person in the user's contact list is a person that the user would like to speak to for business development reasons, then the control command output by the controller 104 to the wearable electronic device 102 may be a command for the wearable electronic device 102 to indicate to the user that the business contact is nearby (e.g., the control command output by the controller 104 to the wearable electronic device 102 may be a command to vibrate, to provide a haptic feedback tap on the user's shoulder, a haptic slide across the user's body to indicate the direction the user should walk to greet the contact, a display on the device indicating the identity of the contact, a display on the device indicating the relevance of the contact to the user's business based on the inferred insight).

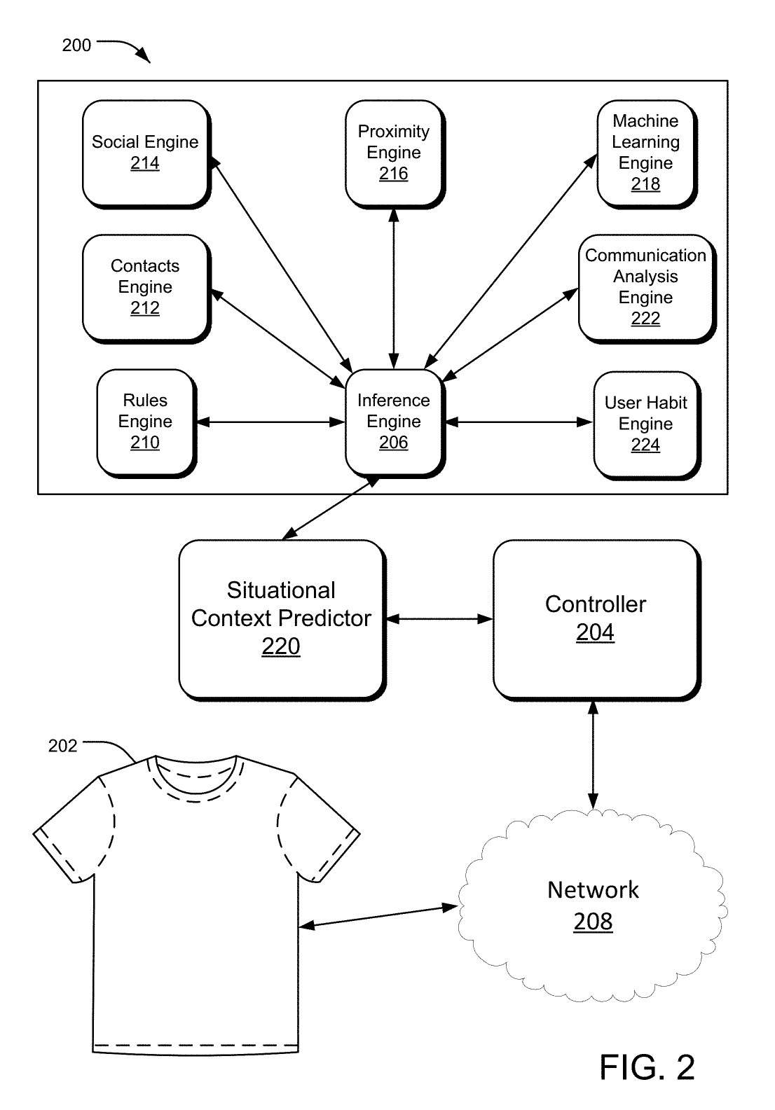

FIG. 2 is a schematic diagram 200 of the components of an example inference engine 206. The diagram 200 illustrates example sub-engines and sub-processes that, in implementations, can be part of the inference engine 206. The inference engine 206 need not include all of the sub-engines and sub-processes shows in FIG. 2.

In at least one implementation, the inference engine 206 includes a contacts engine 212. The contacts engine 212 has access to one or more contact lists associated with the user of the wearable electronic device 202. Contact lists may originate from an online account such as an email account, social media account, etc., from a business account (e.g., a Microsoft Exchange account), a communications account (e.g., Skype), an online directory, a mobile device, etc. Entries in the contact list may include information relating to the contacts that can be used by the inference engine to create new inferred insights. A contact list entry includes an association of the contact with an organization (e.g., business, school, non-profit organization, community organization). A contact list entry may include address(es), phone number(s), birthdate, photo, etc.

The contacts engine 212 may further include historical information relating to the user's prior interactions and communications with the persons represented by the entries in the contact list. In an example, the contacts engine may supply data to the inference engine that the user has unsuccessfully attempted to contact a person in the contact list, but has not received a reply. This information may be used by the inference engine to create an inferred insight that the user wishes to speak to the contact. Such an inferred insight may be used to update the persistent inferred state representing the user to permit a situational context predictor to predict that the user wants to be interrupted by an incoming communication from the contact in a context wherein the user would normally not want to be interrupted. Alternatively, or additionally, the inferred insight may be used to update the persistent inferred state representing the user to permit a situational context predictor to predict that the user wants to be notified by the electronic wearable device 202 if the contact is in physical proximity to the user (e.g., at the same party) such that the user is prompted to initiate a conversation with the contact. In another example, the contacts engine may supply data to the inference engine that the user has received an unreturned voicemail from a contact in the contact list. If the user has a history of not returning voice mails from the contact in the contact list, then this information may be used by the inference engine to create an inferred insight that the user does not wish to speak to the contact. Such an inferred insight may be used to update the persistent inferred state representing the user to permit a situational context predictor to predict that the user does not wish to be interrupted by another incoming communication from the contact.

In at least one implementation, the inference engine 206 includes a social engine 214. The social engine 214 may scrape or search social accounts owned by the user or with which the user has interacted. If the user frequently comments on posts made to social media by a contact in the user's contact list, then the inference engine 206 may create an inferred insight that the user has a high degree of conversational compatibility with the contact. Such an inferred insight may be used to update the persistent inferred state representing the user to permit a situational context predictor to predict that the user wants to be notified by the electronic wearable device 202 if the user is in the same general area as the contact. The social engine 214 may collect information relating to the user's interests based on the user's social media activities. If the user frequently posts comments or links on social media relating to European football teams, then the inference engine 206 may create an inferred insight that the user is interested in European football. Moreover, if the user frequently comments on a particular contact's social media account regarding a particular European football team, then the inference engine 206 may create an inferred insight that that European football team is a topic of interest to the user and the contact. Such an inferred insight may be used to update the persistent inferred state representing the user to permit a situational context predictor to predict that the user would like the wearable electronic device to display a logo of the European football team if the user is in physical proximity to the contact with whom the user discusses the team. In another example, if the user has written a review of an establishment (e.g., restaurant, bar, club) on a social media site, the social engine 214 may analyze the review to determine whether the review was positive or not (e.g., rating given by the user, positive or negative words used in the text of the review).

In at least one implementation, the inference engine 206 includes a machine learning engine 218. The machine learning engine 218 has the ability to learn relationships and to supply data using pattern recognition and computational statistic, among other techniques, to create inferred insights to the inference engine 206 without being explicitly programmed to do so. The machine learning engine 218 may recognize patterns in the user's behavior and supply the patterns to the inference engine 206 to create inferred insights. If the machine learning engine 218 detects patterns in the user's behavior, for example, seeking food when the user's blood sugar is low, then an inferred insight based thereon may be to suggest a restaurant in the area to the user when the user's blood sugar is detected to be low.

In at least one implementation, the inference engine 206 includes a communication analysis engine 222. The communication analysis engine 222 may parse and analyze communications sent or received by the user to mine information relevant to the inference engine 206. If the user receives an order confirmation for a good or service, the email confirmation serves as an indication of the user's interest in that good or service. If the user books a travel reservation to another city, then the confirmation email serves as an indication that the user will be in that city on a certain range of dates. Information relating to the user's relationship with contacts in the user's contact list may be gleaned from the user's communications. If the user frequently sends text messages to a user in the user's contact list that reference meeting the contact “at home,” then the inference engine 206 may create an inferred insight that the user lives at the same house as the contact (e.g., roommate, spouse, family, domestic partner). Such an inferred insight may be used to update the persistent inferred state representing the user to permit a situational context predictor to predict that the user wants to be notified by the electronic wearable device 202 if the contact is planning to travel to the shared house and there is a potential for a shared ride, etc. Communications analyzed by the communication analysis engine 222 may contain email signatures that indicate who the sender is in relation to the user or organizations that the sender may be affiliated with such as business organizations, social organizations, etc. This information may be relied upon to create further inferred insights relating to the contacts who have sent communications to the user.

In at least one implementation the inference engine 206 includes a user habit engine 224. The user habit engine 224 contains profile information relating to the user (e.g., home location, office location, school location, frequently visited locations). If a user consults with an online mapping tool (e.g., Bing Maps), the user may input information into the mapping tool, either explicitly (e.g., home address) or impliedly (e.g., frequently requesting route information from office to a gym) that can be extracted by the user habit engine 224. If the user habit engine detects that the user habitually arrives at school in the morning at a certain time, then the inference engine 206 may create an inferred insight that the user is required to attend school at that time. Such an inferred insight may be used to update the persistent inferred state representing the user to permit a situational context predictor to predict that the user wants to be notified by the electronic wearable device 202 if the user's usual travel route has a high degree of traffic and would require an earlier departure than usual to arrive at school at the habitual time.

In at least one implementation, the inference engine 206 includes a proximity engine 216. The proximity engine 216 may feed information into the inference engine 206 regarding the physical proximity of the user to persons or places that may be of interest to the user. If another component of the inference engine 206, such as the social engine 214 or the contacts engine, etc. has determined that the user has an interest in a person or place, then the proximity engine can feed the proximity data to the inference engine 206. For example, if the communication analysis engine 222 determines that the user frequently buys a preferred brand of mechanical pencil from an online retailer by parsing order confirmation emails in the user's email account received from the online retailer, then the proximity engine 216 may supply proximity information to the inference engine 216 that the user's preferred brand of mechanical pencil is for sale at a discount at a store nearby the user. The inference engine 206 may create an inferred insight based thereon that the user wishes to be notified by the electronic wearable device 202 of the proximity of the store selling the user's preferred brand of mechanical pencil by, for example, a haptic tap on the shoulder when the user is in proximity to the store.

The proximity engine 216 may obtain proximity data in several ways. In at least one implementation, the wearable electronic device 202 include a near field communication sensor that can detect the presence of other electronic devices in an area. In another implementation, the electronic wearable device 202 includes a Wi-Fi antenna that is capable of sensing the SSID of wireless networks in the area of the electronic wearable device 202. The sensed SSIDs of wireless networks may be compared to a list of known wireless networks to determine the physical location of the electronic wearable device 202. In another implementation, the electronic wearable device may include a Global Positioning System (GPS) antenna capable of supplying physical coordinates of the wearable electronic device 202. In yet another implementation, the wearable electronic device 202 includes a Radio Frequency Identification (RFID) tag and sensor configured to sense the presence of other wearable electronic devices in the area of the electronic wearable device 202. Use of an RFID tag also permits the wearable electronic device to supply additional identifying information to other electronic devices in proximity to the wearable electronic device 202. In another implementation, the wearable electronic device 202 updates its physical location in a shared online location (e.g. a cloud storage location) wherein only individuals or contacts with whom the user of the wearable electronic device 202 has chosen to share physical location data with may access the current physical location of the electronic wearable device 202. The electronic wearable device 202 may poll the online location to obtain the physical locations of contacts who have chosen to share their physical locations with the user of the wearable electronic device 202. The proximity engine may supply this proximity information to the inference engine 206 to create new inferred insights regarding context of the user when in physical proximity to the areas or persons of interest to the user.

In at least one implementation, the inference engine 206 includes a rules engine 210. The rules engine 210 may contain rules programmed into the inference engine 206. As an example, if the user is identified as a minor child, then the rules engine 210 may be programmed to prevent certain inferred insights (e.g., attendance at an event serving alcohol). In the example system 200, inferred insights are communicated to the situational context predictor 220 for use in the controller 204 for sending control commands to the electronic wearable device 202.

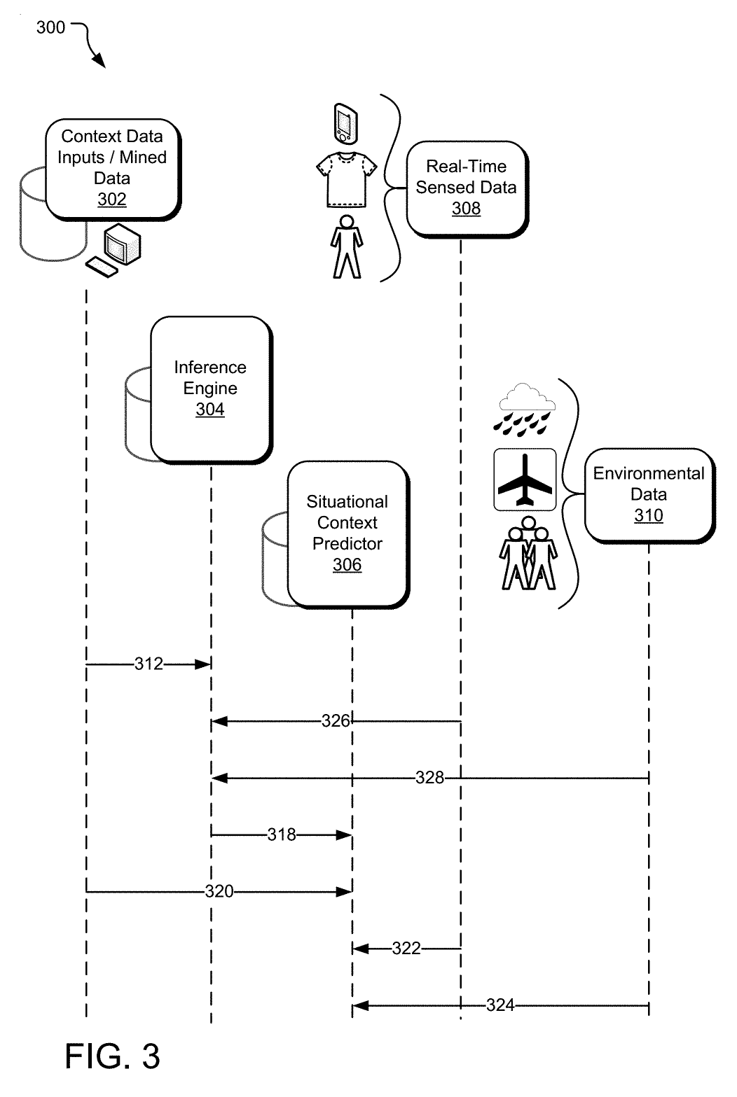

FIG. 3 is a signal diagram 300 illustrating example collection of data at a situational context predictor 306 from an inference engine 304, sensed data from a wearable electronic device 308, and environmental data 310. An inference engine 304 receives context data inputs and mined data relating to an individual user from sources 302 at communication 312, real time sensed data from a wearable electronic device 308 at communication 326, and environmental data 310 relating to the environment around the user (e.g., weather, traffic, locations of contacts, travel schedule data) at communication 328. The context data inputs and mined data may include some or all of data collected from social media platforms, contacts of a user, proximity data relating to the user, analysis of communications of the user, the user's habits and habitual data, and organized according to a rules engine and machine learning engine. The inference engine 304 creates one or more new inferred insights to update a persistent inferred state supplied to situational context predictor 306 at communication 318. The situational context predictor 306 may receive additional context data inputs and mined data from sources 302 at communication 320 and real-time sensed data from a wearable electronic device 308 at communication 322. The real-time sensed data from a wearable electronic device 308 describes the sensed current state of the user and/or the current state of the user's environment. At communication 324, the situational context predictor 306 receives environmental data 310 relating to the environment around the user (e.g., weather, traffic, locations of contacts, travel schedule data).

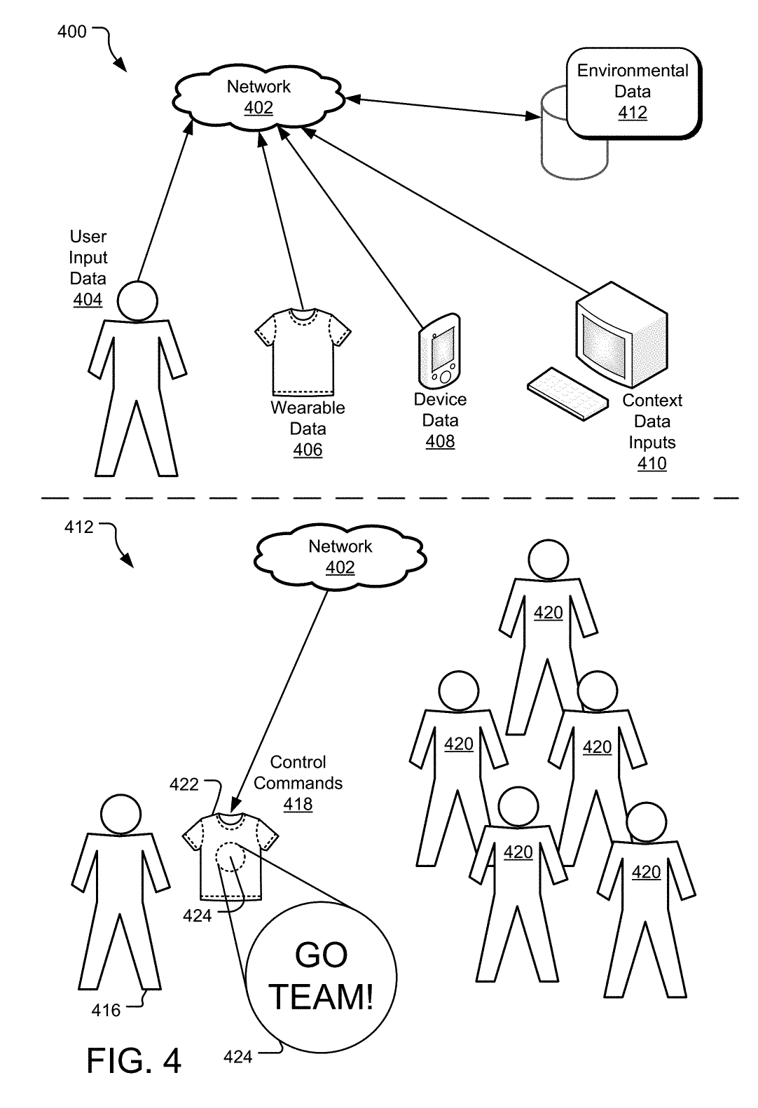

FIG. 4 illustrates example control of an electronic wearable device 422 with inferred insights. In area 400, data is supplied to an inference engine and context predictor via a network 402 from multiple sources. The sources include direct input of data by a user (e.g., supplying a home address to a digital personal assistant, map tool), data sensed by a wearable electronic device 406, data collected from an electronic device associated with the wearable device 408 (e.g., another wearable device, a smart phone, a watch), context data inputs 410 from sources including social media platforms, contact lists, information gleaned from interaction with a digital personal assistant, analysis of communication data, habitual user data), and environmental data 412 regarding information about the user's environment (e.g., travel data, traffic data, weather data, emergency information data, data supplied by a government agency). The inference engine outputs new inferred insights based on the data 404, 406, 408, 410 to update a persistent inferred state describing the situational context of the individual user based on the new inferred insights.

In area 412, the wearable electronic device 422 receives control commands 418 via the network 402 from a context predictor. In an example, the user 416 enters into a proximity to persons 420 who are contacts of the user and have a relationship to the user as members of the same baseball team in the persistent state describing the situational context of the individual user 416. The persons 420 who are contacts of the user are identified as members of the same baseball team from context data inputs and mined data input into an inference engine to create new inferred insights regarding the individual user 416. Sources of the context data inputs that created the inferred insight that the persons 420 are on the same baseball team as the individual user 416 may include, for example, interactions with the persons 420 on social media platform, identifications of the persons 420 in the user's contacts list, analysis of the user's communications with the persons 420 or about the persons 420, etc. Interactions with the persons 420 on social media platforms may include indications that the persons 420 are associated with the individual user 416 by way of membership on the same baseball team (e.g., membership in a group affiliated with the baseball team, communications with one or more of the persons involving keywords related to baseball).

If the situational context predictor receives sensed data that the user is in proximity to the user's baseball teammates (e.g., data from the wearable electronic device 422 that the persons 420 are present) and/or environmental data that the user is in proximity to the user's baseball teammates (e.g., location data of the persons 420 made available on social media or via cloud contacts, communications indicating that the teammates will be in the location confirmed by the wearable electronic device 422 sensed data), the context may be predicted that the user is, in fact, with the user's baseball team and that the wearable electronic device should display a message 424 relating to the element the user has in common with the persons 420, e.g., a message supporting the baseball team. Other examples of predicted situational contexts include audio signals that are associated with the baseball team such as a team song, activation of an imaging device that may tag images of the situational context as belonging to a gathering of the baseball team, etc. A controller receives the predicted situational context and transmits control commands 418 to the wearable electronic device 422 to execute the predicted situational context actions.

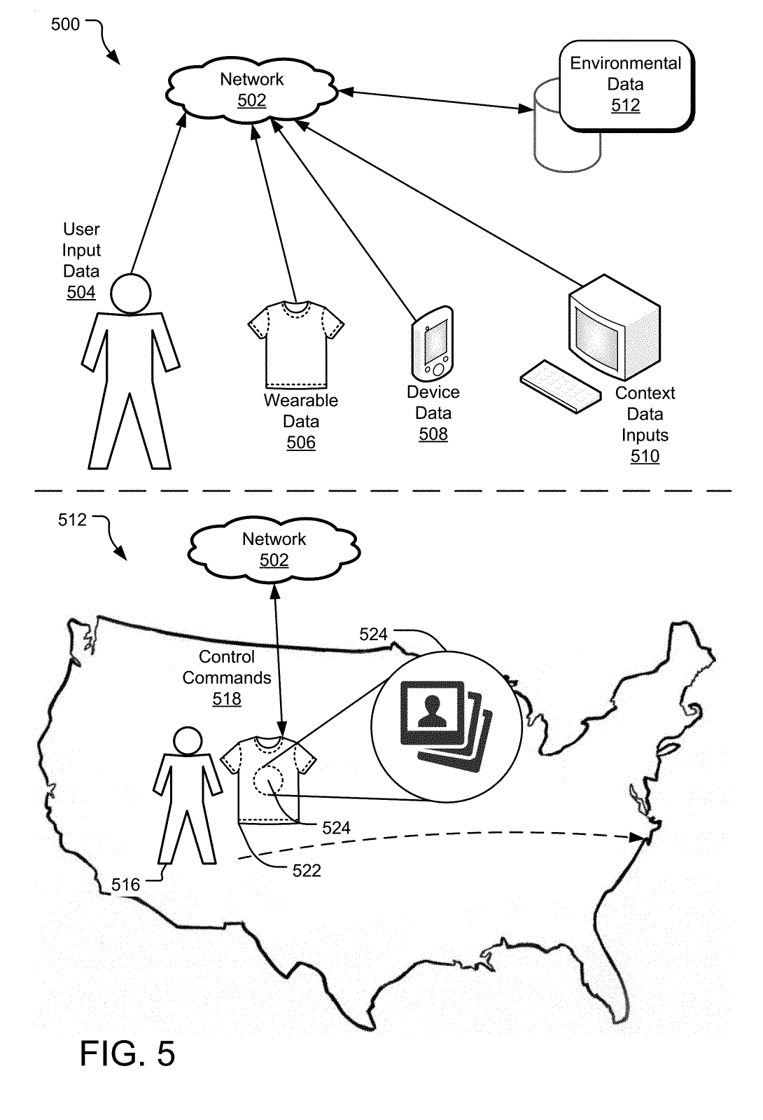

FIG. 5 illustrates example control of an electronic wearable device 522 with inferred insights. In area 500, data is supplied to an inference engine and context predictor via a network 502 from multiple sources. The sources include direct input of data by a user (e.g., supplying a home address to a digital personal assistant, map tool), data sensed by a wearable electronic device 506, data collected from an electronic device associated with the wearable device 508 (e.g., another wearable device, a smart phone, a watch), context data inputs 510 from available sources (e.g., social media platforms, contact lists, information gleaned from interaction with a digital personal assistant, analysis of communication data, habitual user data), and environmental data 512 regarding information about the user's environment (e.g., travel data, traffic data, weather data, emergency information data, data supplied by a government agency). The inference engine outputs new inferred insights based on the data 504, 506, 508, 510 to update a persistent inferred state describing the situational context of the individual user based on the new inferred insights.

In area 512, the wearable electronic device receives control commands 518 via the network 502 from a context predictor. In an example, the user 516 is embarking on a cross-country trip to attend the funeral of a deceased relative. That the user 516 is in the situational context of traveling to the funeral is reflected in the updated persistent state describing the situational context of the individual user 516. The updated persistent state describing the situational context is based on context data inputs and mined data input into an inference engine to create new inferred insights regarding the individual user 516. Sources of the context data input that created the new inferred insight that the user 516 is traveling to attend the funeral may include, for example, analysis of communications sent by or to the user in which the funeral date, time, and/or location is mentioned. The communications may further indicate information on which the identity of the deceased relative may be inferred in an inferred insight. A service provided to the user 516 may be based on the inferred insight may include a slideshow 524 on the electronic wearable device of photos in which the deceased relative has been tagged.

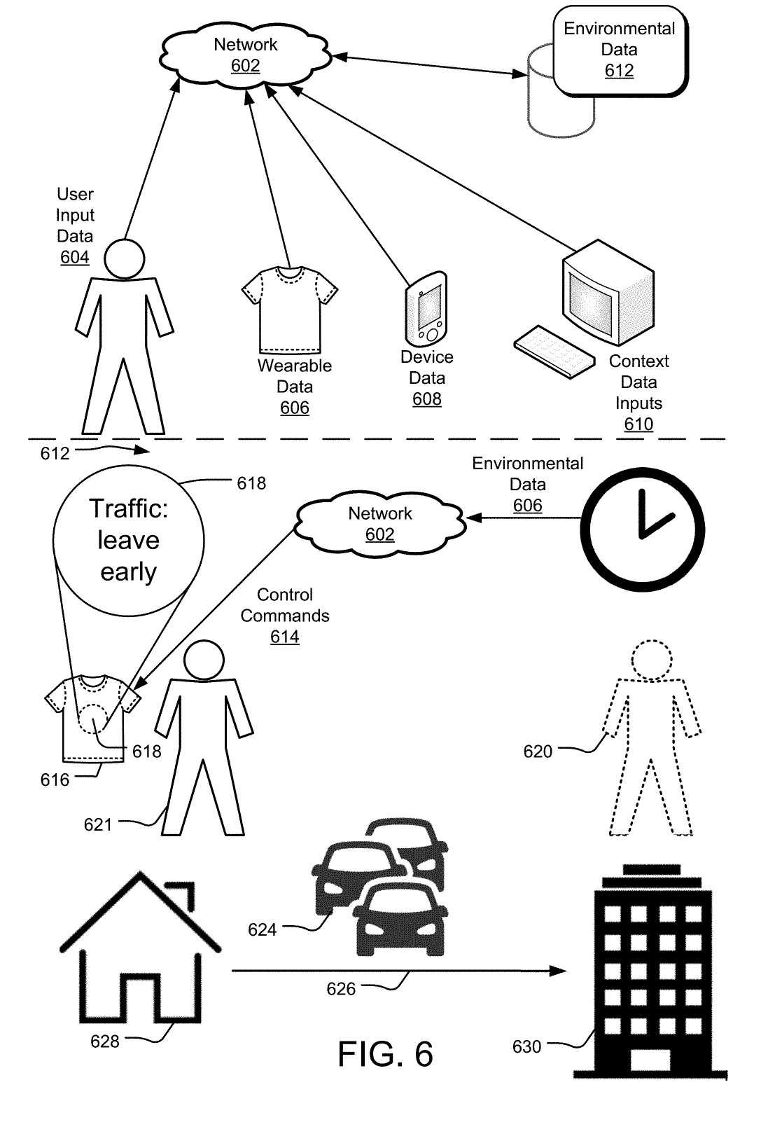

FIG. 6 illustrates example control of an electronic wearable device 622 with inferred insights. In area 600, data is supplied to an inference engine and context predictor via a network 602 from multiple sources. The sources include direct input of data by a user (e.g., supplying a home address to a digital personal assistant, map tool), data sensed by a wearable electronic device 606, data collected from an electronic device associated with the wearable device 608 (e.g., another wearable device, a smart phone, a watch), context data inputs 610 from sources including social media platforms, contact lists, information gleaned from interaction with a digital personal assistant, analysis of communication data, habitual user data), and environmental data 612 regarding information about the user's environment (e.g., travel data, traffic data, weather data, emergency information data, data supplied by a government agency). The inference engine outputs new inferred insights based on the data 604, 606, 608, 610 to update a persistent inferred state describing the situational context of the individual user based on the new inferred insights.

In area 612, the wearable electronic device 616 receives control commands 614 via the network 602 from a context predictor. In an example, the user 620 enters is at the user's home 628. A predicted situational context is based on sensed data that the user is at the user's home (e.g., GPS data received from the wearable electronic device 616 and data collected from a virtual personal assistant to the user that the location is the user's home) and an inferred insight that the user will wish to travel to another location such as a gym 630 via a route 626 and arrive at a certain time (e.g., based on habitual user data) suggests to the situational context predictor to send a control command 614 to the wearable electronic device to display a message 618 to the user to leave early if environmental data suggests that the user should leave earlier than normal to arrive at the gym 630 at the user's habitual time (e.g., traffic data 624, time data 606).

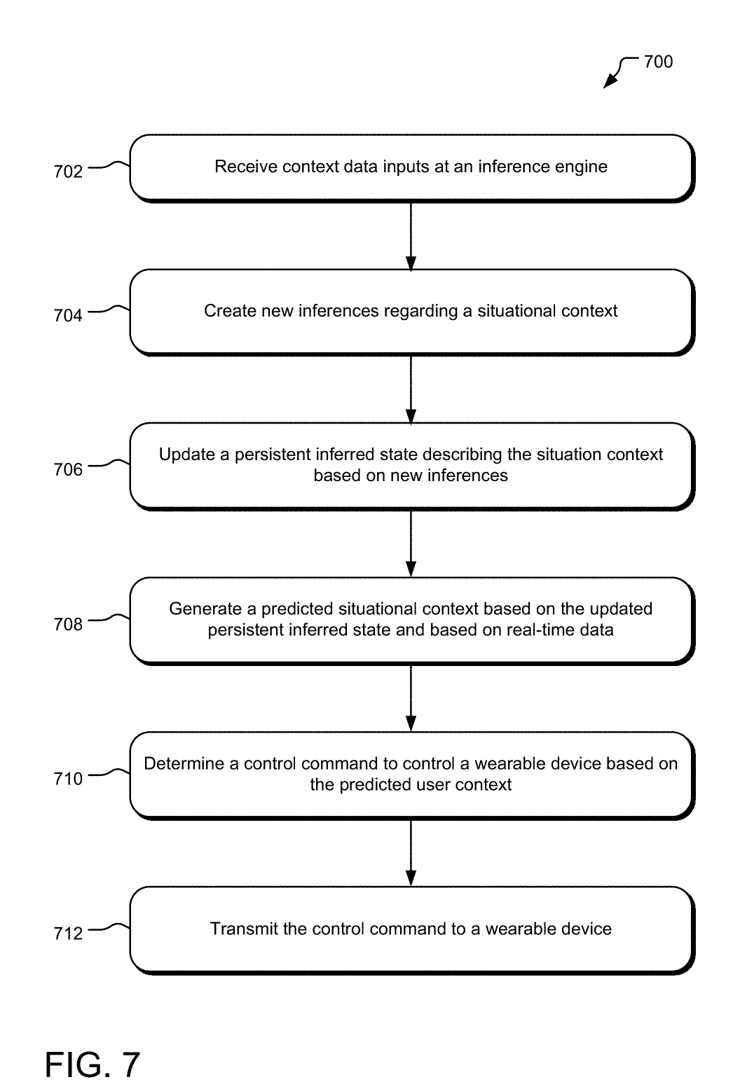

FIG. 7 illustrates example operations 700 for generating inferred insights to determine control commands to send to a wearable device associated with an individual user. A receiving operation 702 is to receive context data inputs at an inference engine. The context data inputs may include data collected from a personal digital assistant to the user, data from the user's contact list, data mined from social media platforms regarding the user and/or the user's interactions with other users and groups of users, analysis of communications sent by or to the user by others, habitual user data, etc.

An inference creating operation 704 uses the inference engine to create new inferences (e.g., inferred insights) regarding a situational context of the user. The inferred insights are not solely data explicitly included in the context data inputs, mined data, etc. Instead, inferred insights are conclusions based on the context data inputs using analysis such as user habits, machine learning, pattern recognition, etc., that represent new inferences. In an implementation, the creating operation 704 discards one or more of the context data inputs if the one or more of the context data inputs do not satisfy a quality condition. An example of a quality condition is whether the context data input originates from a trusted source. Another example of a quality condition includes a weighting system wherein context data inputs from certain sources are weighted according to the likelihood that the one or more context data inputs will provide a basis for a useful or desired inferred insight. A user may provide weights to be used in weighting context data inputs. Alternatively, or additionally, past user actions may be relied upon to set or revise weights assigned to various context data inputs. Weights assigned to context data inputs from certain sources may vary over time or may be blended with other values, such as a confidence value that the context data input is correct or not stale. In an implementation, if the weight assigned to a context data input is below a threshold value, then the creating operation 704 may discard the context data input such that no inferred insights will be based on the discarded context data input. For example, if a user of a wearable device has interacted with the wearable device in the past to indicate that material generally considered unsuitable for a workplace environment is nonetheless wanted by the user to be displayed on the wearable device even if the user is at work, then the context data input that the user is at work may be assigned a low weight and discarded if the low weight is below the threshold value.

An updating operation 706 updates a persistent inferred state describing the situational context based on the new inferred insights. The persistent situational context describing the user is a collection of inferences and data that describe the user's relationship to the contacts, places, and data that may be acted on by the wearable electronic device.

A generating operation 708 generates a predicted situational context based on the updated persistent inferred state and based on real-time data. The real-time data may include data sensed by the wearable electronic device as well as environmental data that informs the updated persistent state of the environment in which the user may be found. A determining operation 710 determines a control command to control the wearable device based on the predicted user context. The control command may be to provide a service to the user based on the predicted situational context. A transmitting operation 712 transmits the control command to the wearable electronic device to execute the command.

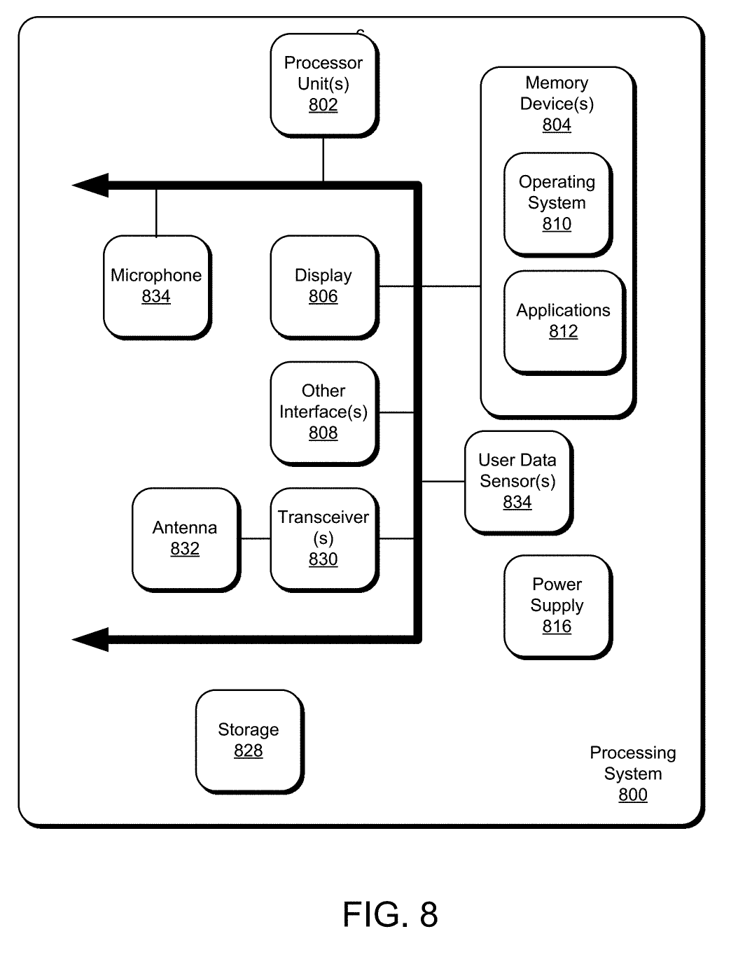

FIG. 8 illustrates an example system 800 for use in an example system for a wearable device associated with an individual user that is controlled based on inferred insights. The processing system 800 includes one or more processor units 802 (discrete or integrated microelectronic chips and/or separate but integrated processor cores), at least one memory device 804 (which may be integrated into systems or chips of the processing system 800), the display 806 (e.g., a touchscreen display, an OLED display with photodetectors, etc.), and other interfaces 808 (e.g., a touch keyboard interface). The memory device 804 generally includes both volatile memory (e.g., RAM) and non-volatile memory (e.g., flash memory). An operating system 810, such as one of the varieties of the Microsoft Windows® operating system, resides in the memory device 804 and is executed by at least one of the processor units 802, although it should be understood that other operating systems may be employed. Other features of the electronic device 800 may include without limitation a user data sensor(s) 834 (e.g., blood pressure sensor, temperature sensor, heart rate monitor, etc.).

One or more applications 812, such as image scanning software, triggering software, sensor control instructions, etc., are loaded in the memory device 804 and executed on the operating system 810 by at least one of the processor units 802. The processing system 800 includes a power supply 816, which is powered by one or more batteries and/or other power sources and which provides power to other components of the processing system 800. The power supply 816 may also be connected to an external power source that overrides or recharges the built-in batteries or other power sources.

The processing system 800 includes one or more communication transceivers 830 to provide network connectivity (e.g., mobile phone network, Wi-Fi®, Bluetooth®, etc.). The processing system 800 also includes various other components, such as a positioning system 820 (e.g., a global positioning satellite transceiver), one or more accelerometers 822, one or more cameras 824, one or more audio interfaces (e.g., an audio interface, such a microphone, an audio amplifier and speaker and/or audio jack), one or more antennas (832), and additional storage 828. Other configurations may also be employed.

In an example implementation, a mobile operating system, various applications, modules user data sensing (e.g., fingerprint recognition), device access control, security, and other modules and services may be embodied by instructions stored in the memory device 804 and/or storage devices 828 and processed by the processing unit 802. Security and access control parameters, training fingerprint patterns, and other data may be stored in the memory device 804 and/or storage devices 828 as persistent data stores.

The processing system 800 may include a variety of tangible processor-readable storage media and intangible processor-readable communication signals. Tangible processor-readable storage can be embodied by any available media that can be accessed by the processing system 800 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the processing system 1400. In contrast to tangible processor-readable storage media, intangible processor-readable communication signals may embody processor readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared and other wireless media.

Some embodiments may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one embodiment, for example, an article of manufacture may store executable processor program instructions that, when executed by a processor, cause a computer to perform methods and/or operations in accordance with the described embodiments. The executable processor program instructions may include any suitable type of code, such as source code, compiled code, interpreted code, executable code, static code, dynamic code, and the like. The executable processor program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of controlling a wearable device, the method comprising:
receiving context data inputs relating to an individual user;
creating one or more new inferences regarding the individual user based on the context data inputs;
generating an adjustable persistent inferred state, the adjustable persistent inferred state representing a collection of inferences regarding the individual and including the one or more new inferences;
generating a predicted situational context based on the updated persistent inferred state and further based on sensed real-time data;
determining a control command to control the wearable device associated with the individual user based on the predicted situational context; and
transmitting the control command to the wearable device associated with the individual user.

2. The method of claim 1, wherein the generating the adjustable persistent inferred state operation includes altering an existing adjustable persistent inferred state.

3. The method of claim 1, wherein the generating the adjustable persistent inferred state operation includes creating a new adjustable persistent inferred state.

4. The method of claim 2, wherein the generating the adjustable persistent inferred state operation includes removing stale inferences from the existing adjustable persistent inferred state.

5. The method of claim 1, wherein the generating the adjustable persistent inferred state operation includes weighting one of the one or more new inferences based on the quality of one of the context data inputs.

6. The method of claim 1, wherein the creating operation discards one of the one or more context data inputs if the one of the one or more context data inputs does not meet a quality condition.

7. The method of claim 1, wherein the context data inputs include communications sent or received by the individual user.

8. The method of claim 1 wherein the context data inputs include data collected by a digital personal assistant to the individual user.

9. The method of claim 1, wherein the sensed real-time data includes the current geographic position of contacts in the individual user's address book.

10. The method of claim 1, wherein the generating a predicted situational context operation is based at least in part on habitual user data.

11. A system for controlling a wearable device, the system comprising:
an inference engine configured to receive context data inputs relating to an individual user, the inference engine further configured to create one or more new inferences regarding the individual user based on the context data inputs;
an adjustable persistent inferred state representing a collection of inferences regarding the individual user and including the one or more new inferences;
a situational context predictor configured to generate a predicted situational context based on the adjustable persistent inferred state and further based on sensed real-time data; and
a controller configured to determine a control command to control a wearable device associated with the individual user based on the predicted situational context, the controller further configured to transmit the control command to the wearable device associated with the individual user.

12. The system of claim 11 wherein the real-time data includes physical proximity to persons in an address book of the individual user.

13. The system of claim 11, wherein the situational context predictor is further configured to modify the predicted situational context based in part on habitual user data.

14. The system of claim 13, wherein the habitual user data includes physical locations frequently visited by the individual user.

15. The system of claim 11, wherein the control command includes an incoming communication request for the individual user.

16. The system of claim 15, wherein the control command includes a command to alert the user of an incoming communications request for the individual user if the situational context predictor determines that an identity of the sender of the incoming communications request satisfies an interruption condition.

17. One or more tangible processor-readable storage media embodied with instructions for executing on one or more processors and circuits of a device a process for controlling a wearable device, the process comprising:
receiving context data inputs relating to an individual user;
creating one or more new inferences regarding the individual user based on the context data inputs;
generating an adjustable persistent inferred state, the adjustable persistent inferred state representing a collection of inferences regarding the individual and including the one or more new inferences;
generating a predicted situational context based on the updated persistent inferred state and further based on sensed real-time data;
determining a control command to control the wearable device associated with the individual user based on the predicted situational context; and
transmitting the control command to the wearable device associated with the individual user.

18. The one or more tangible processor-readable storage media of claim 17, wherein the process further comprises:
generating the adjustable persistent inferred state operation by altering an existing adjustable persistent inferred state.

19. The one or more tangible processor-readable storage media of claim 17, wherein the process further comprises:
generating the adjustable persistent inferred state operation by creating a new adjustable persistent inferred state.

20. The one or more tangible processor-readable storage media of claim 17, wherein the process further comprises:
generating the adjustable persistent inferred state operation by removing stale inferences from the existing adjustable persistent inferred state.
